(19) United States
(12) Patent Application Publication
(10) Pub. No.: US 2013/0004177 A1
(43) Pub. Date: Jan. 3, 2013

(54) INFRARED CONTROLLABLE LOAD CONTROL SWITCH

(75) Inventor: Jorge Deligiannis, Ottawa (CA)

(73) Assignee: ENERGATE INC., Ottawa (CA)

(21) Appl. No.: 13/173,789

(22) Filed: Jun. 30, 2011

(51) Int. Cl. H04B 10/00; H02B 1/24

(52) U.S. Cl. 398/106; 307/112

(57) ABSTRACT

A load control switch with an infra-red receiver to enable consumer Opt-out of load control events is provided. Load control switches are utilized by utilities to control power demand during peak periods by disconnecting remotely consumer loads. By using any infra-red remote control a consumer can Opt-out of a load control event by signalling to the load control switch that the load control event is to be masked therefore not disconnecting the electrical load from the electrical supply.

### TECHNICAL FIELD

The present disclosure relates to energy management, and in particular to load control switches.

### BACKGROUND

Load control switches can disable major loads such as air conditioning compressors, pool pumps, and water heaters to enable utilities to reduce power loads at peak times and conserve energy. Utilities can conveniently manage energy use and reduce peak demand by disabling consumer loads during peak usage hours. The utility wirelessly signals to the load control switch that the load is to be disconnected from the electrical supply provided by the utility. The wireless signals in the form of load control event messages are typically one way signals from the utility to the load control switch using technology such as one-way Very High Frequency (VHF), paging, or frequency modulation radio data system (FM RDS) broadcasts to activate the load control switch and disable any connected loads. Alternatively other types of networking may be supported by two-way communication systems such as Zigbee or Wi-Fi to interface with smart meter or larger utility mesh network to receive load control event messages. The load control event messages direct the load control switch to disconnect the load from the power supply; however there may be times when a consumer requires use of attached loads and may wish to Opt-out of a utility load control event.

Accordingly, apparatus and methods that enable improved load control switch Opt-out functionality remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of an application of a load control switch;

FIG. 2 shows a schematic representation of an infra-red load control switch;

FIG. 3 shows a method of operating a load control switch; and

FIG. 4 shows an alternate method of operating a load control switch.

It will be noted that throughout the appended drawings, like features are identified by like reference numerals.

### DETAILED DESCRIPTION

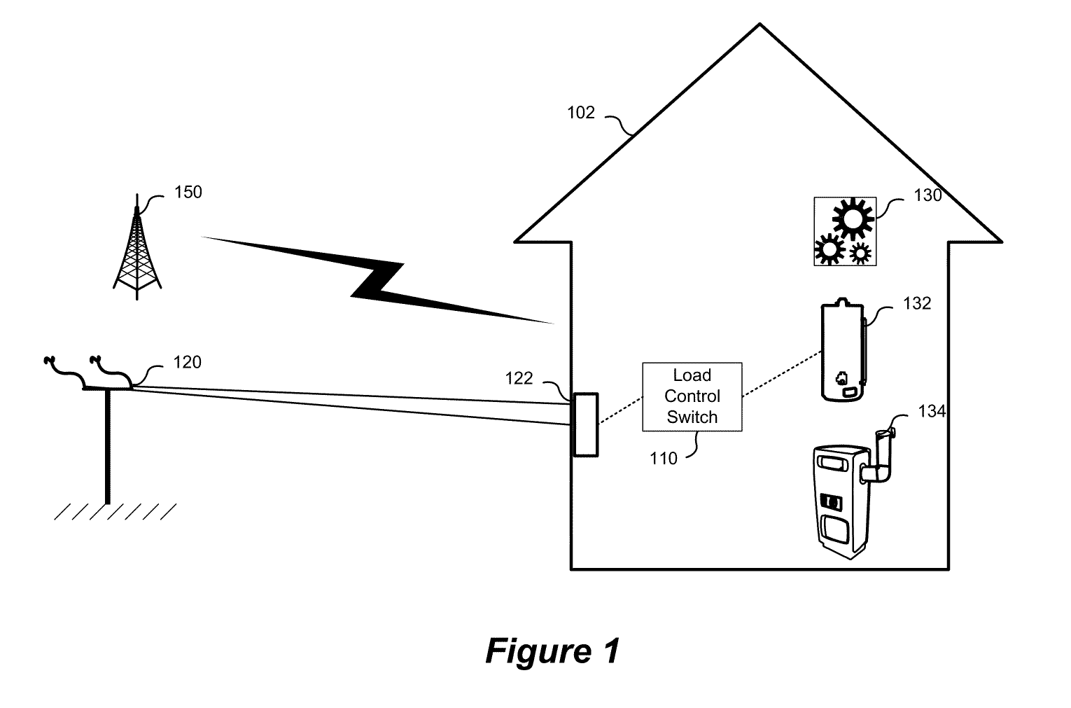

Embodiments are described below, by way of example only, with reference to FIGS. 1-4.

In accordance with an aspect of the present disclosure there is provided a method of operating a load control switch coupled between an electrical supply and an electrical load. The method comprising receiving an infra-red signal at the load control switch; and masking a load control event when the infra-red signal is sustained for a pre-defined time interval, the load control event defining one or more time periods during which the electrical load is to be disconnected from the supply by the load control switch.

In accordance with another aspect of the present disclosure there is provided a load control switch comprising an infra-red receiver; a switch coupling and electrical supply and electrical load wherein the switch enables the electrical load to be disconnected from the electrical supply; a processor for: receiving an infra-red signal from the infra-red receiver; and masking a load control event when the infra-red signal is sustained for a pre-defined time interval, the load control event defining one or more time periods during which the switch is to disconnect the electrical load from the supply.

A load control switch allows a utility to turn off electrical loads like pool pumps and electric water heaters during times of peak energy demand. The periods of time that the utility turns off these loads is called a “load control event”. The present disclosure provides a load control switch that enables a consumer to Opt-out of a load control event by using a remote control. The remote control generates an infra-red (IR) signal which identifies to the load control switch to Opt-out or mask the load control event and thereby cease disconnecting the load during the load control event. The user of IR signals allows the consumer to control the load control switch without physically interacting with the load control switch eliminating any safety concerns.

The load control switch can receive IR signals from any remote control that utilize IR signalling in 940 nm to 980 nm wavelength range but other IR compatible ranges can be utilized. For example any television, satellite, cable, DVD etc. remotes may be utilized as the IR signal is not dependent on the coding of the IR signal, rather the duration and period of the IR signal is utilized to signify that the consumer or user wish to Opt-out of a load control event. The use of an IR receiver on the load control switch removes the need for a switch or button requiring a user to interact with.

If the utility sends a load control event message in which a consumer does not wish to participate, the consumer can use a remote control to signal to the load control switch to reconnect the electrical load or opt-out of an upcoming event.

FIG. 1 shows a representation of load control using a load control switch. The load control switch is provided in or associated with a residence 102. The load control switch 110 is couples an electrical supply from an electrical distribution panel 122 receiving power from a utility 120 to one or more electrical loads 130, 132, 134. The load control switch 110 may alternatively be positioned instead to interrupt the 24 VAC control signal loop that controls outdoor heat pump and air-conditioning compressor units. The utility provides a load control event message wirelessly via a distribution network 150 through VHF, paging, or FM RDS signal broadcast to a desired service area or through two-way signals transmitted from Advanced Meter Infrastructure enabled “Smart Meters”, or through two-way signals transmitted from a gateway device in or near the premises. The load control event message identifies one or more time periods for which the load control switch 110 is to disconnect an associated load 130, 132, 134 from the electrical supply. The time periods may define a single instance or a schedule of time periods to disconnect the loads from the electrical supply. The load control event may be addressed to load control switches coupled to a particular load such as a water heater 132 or may be defined as any type of device that a consumer may not need to use during peak demand periods such as for example a pool pump 130. When a load control event message is received wirelessly by the load control switch 110, the load control switch 110 disconnects the associated load, for example a water heater 132 from the electrical supply 120 for the defined period of time.

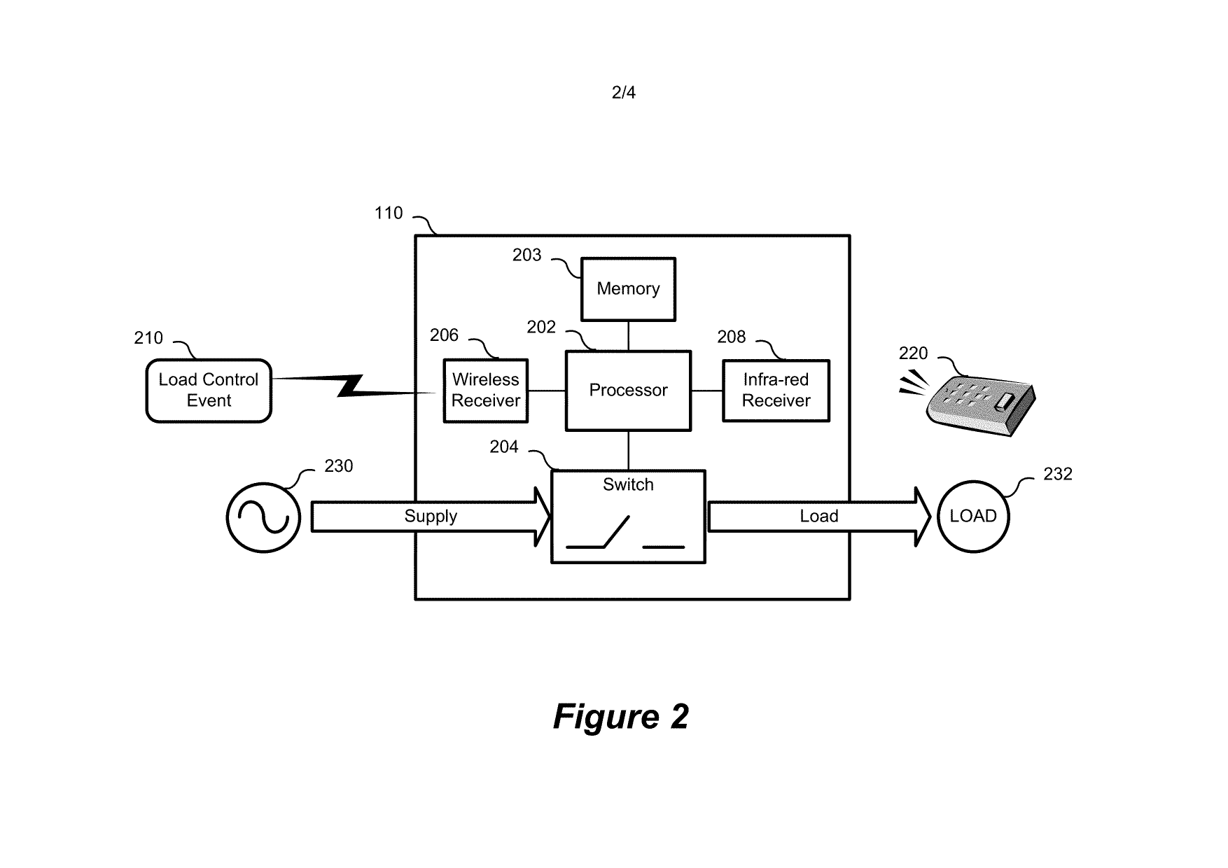

FIG. 2 shows a representation of an infra-red load control switch 110. The load control switch 110 couples an alternating current (AC) supply 230 and an electrical load 232 via a relay or switch 204. The switch 204 is controlled by a processor 202 which receives a load control event message 210 from the associated utility by a wireless receiver 206, such as a FM receiver. Other networking such as Wi-Fi or Zigbee may be utilized to deliver the load control event message to the load control switch 110 one-way radio frequency signals may be utilized. The processor 202 receives the load control event message and determines when and how the load event is to occur. For example the load event message may define that the load control switch should disconnect for a designated period of time when the message is received, or the load event message 210 may designate one or more time periods in the future that load is to be disconnected. The load events may be stored in memory 203 in addition with instructions for how to process load event messages and control the switch 204 as well as function for processing wireless and IR signals. The load control switch 110 also provides an IR receiver 208 coupled to the processor 202. The IR receiver 208 can receive IR signals from any remote control 220 to identify when a consumer wants to Opt-out of the load control event. The IR signal can be an unencoded signal allowing any remote control to be used to trigger the Opt-out of the load control event. When the IR receiver receives an IR signal having minimum pulse duration for a maximum period the processor determines that a load control event should be masked, or opted-out of. For example the IR signal can be defined by pulses lasting at least 350 μsec and be repeated with a period no longer than 3 msec in order to trigger an Opt-out of an event. Defining the pulse length and period ensure that spurious IR from indirect sources don't trigger the load control Opt-out function. In addition the IR receiver may provide limited receiver range to require that the remote control transmitter be within close proximity of the IR receiver 208 in order to eliminate any inadvertent triggering.

The load control event can be temporarily masked, or bypassed thereby not disconnecting the associated load from the electrical supply at the time period designated by the load control event message 210. Masking of the load control event allows the event to be reinstated or pre-emptively opted-out by the consumer. Alternatively masking may refer to the load control event being removed or deleted thereby not allowing the user to reinstate the event once an Opt-out has been initiated.

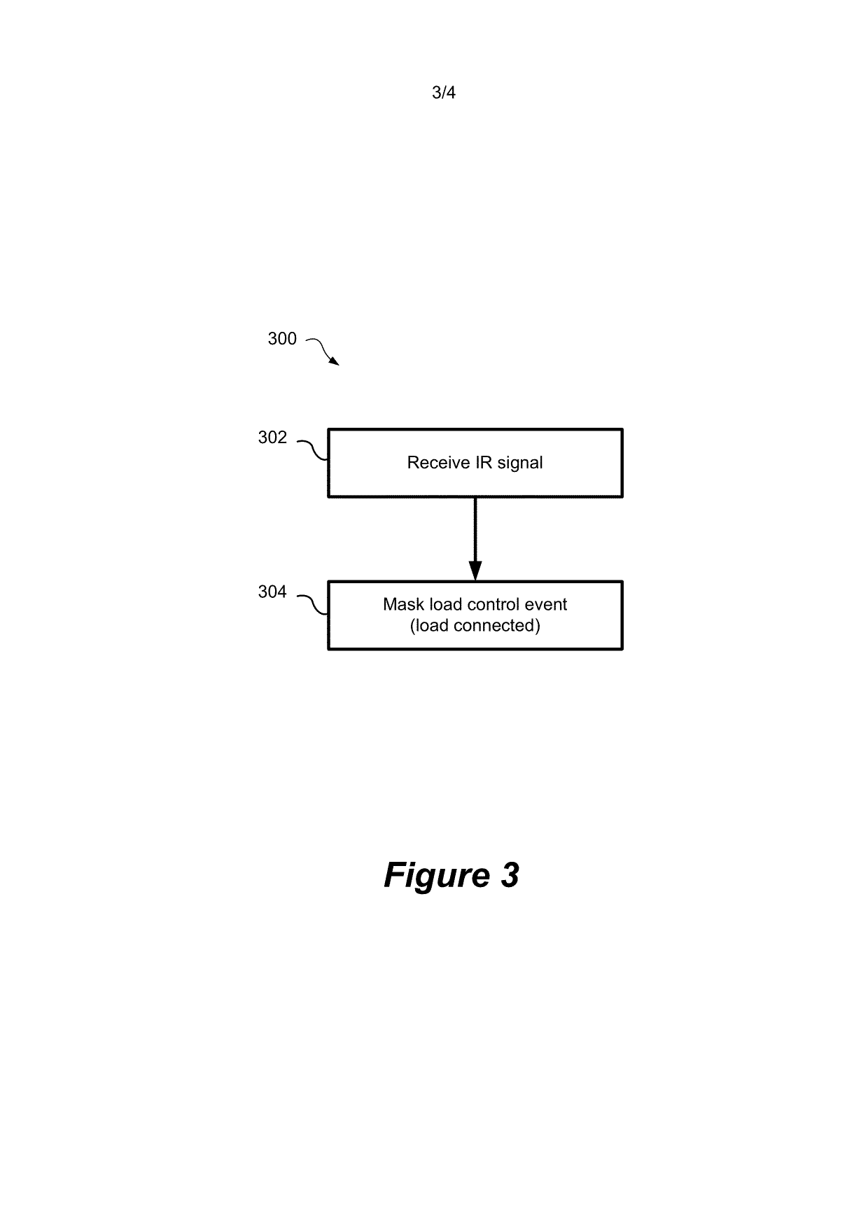

FIG. 3 shows a method 300 of operating a load control switch 110. The IR receiver of the load control switch receives an IR signal from a remote control (302). The load control event is then masked when the infra-red signal is sustained for a pre-defined time interval (304) either reconnecting a load to the electrical supply or not allowing the load to be disconnected when the load control event occurs. The load control event can define one or more time periods during which the electrical load wiring is to be disconnected from the supply wiring by the load control switch. Depending on the configuration of the load control switch the Opt-out may occur for all time periods associated with the event or for the closest time period.

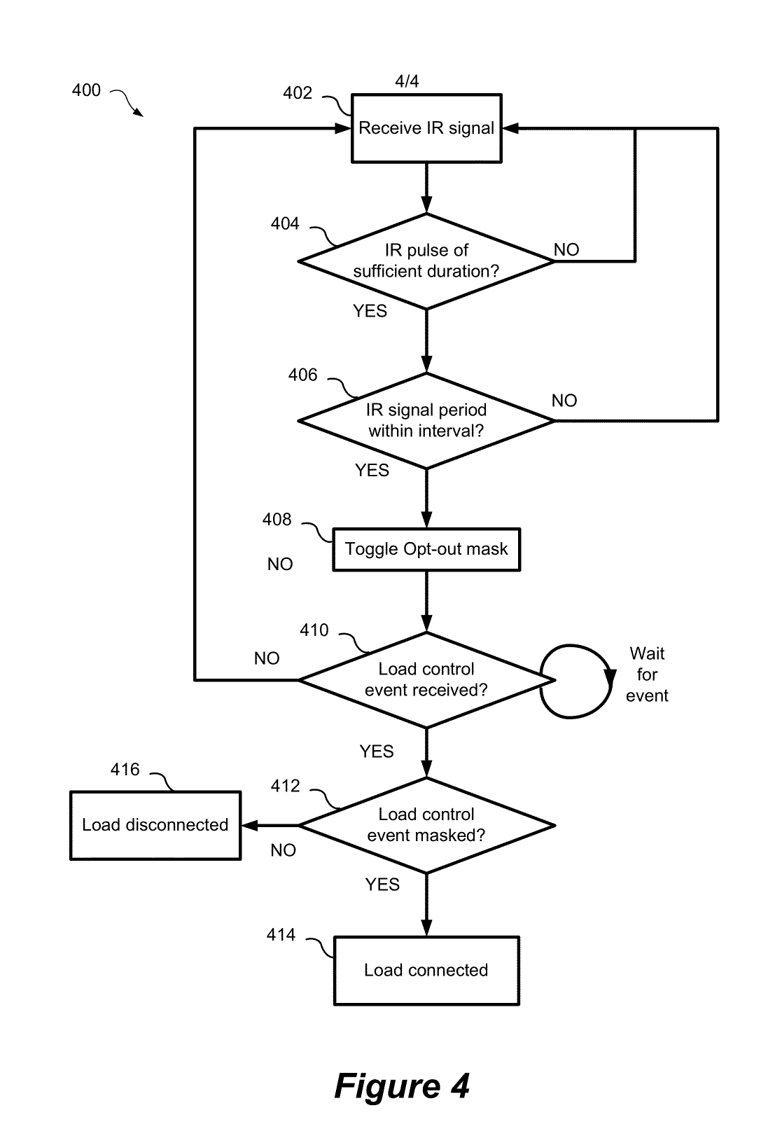

FIG. 4 shows an alternate method of operating a load control switch 110. An IR signal is received at the load control switch 100 (402). The processor 202 determines if the IR pulse is of sufficient duration (404), for example at least 350 usec. If the pulses are of sufficient duration (YES at 404) it is then determined if the period over which IR pulses have been received is within a defined interval, (406) for example no longer than 3 msec. If the period does not exceed the interval (YES at 406) the Opt-out mask is toggled (408). The toggling of the mask will enable or disable the load control event Opt-out depending on what the previous state was. If a load control event message has been previously received by the wireless receiver (YES at 410) the load control event will be masked and therefore the electrical load will not be disconnected by the switch. If the load control event has not been received or has not been previously defined (NO at 410) the method continues until another IR signal is received or a load control event message is received that the mask can be applied to. If the mask has been toggled to Opt-out (YES at 412), the load control event is masked (414) so that the electrical load is not disconnected from the electrical supply during the period defined by the load control event or is reconnected if it was previously disconnected. If the mask has not been toggled (NO at 412), the load control event is allowed to occur (416) and the electrical load is disconnected from the electrical supply. If an Opt-out request is received during a load control event the mask may be applied and the electrical load connected to the supply to mask the load control event. The assumption is that the default status of the load control switch is always connected to the electrical load.

Alternatively the toggling of the Opt-out mask may require a different duration of IR signal to be received, for example activation the Opt-out may require a shorter IR signal to be received than cancellation of an Opt-out request. In addition a timer mechanism may be implemented so that an Opt-out request may be reset if an event has not occurred in a certain period of time. For example if a user expects a load control event request to occur for a water heater and pre-emptively Opts-out and the load control event does not occur, the mask would be reset after a time period expires for example 12 or 24 hours. Depending on the configuration of the load control switch 110, the Opt-out may be applied to a load control event as a whole, or to a time period defined by the load control event where multiple time periods are defined. For example an Opt-out request may only be applied to the first hour of a three hour load request event. Alternatively, a load control event message may program the load control switch to disconnect a load at defined time periods for a predefined schedule, for example every weekday afternoon for the next two months. In this example the Opt-out message would need to be received for each occurrence of the load control event in order to Opt-out of the particular occurrence of the event.

In order to provide feedback to a consumer of the load control switch a window or display with indicator lights may be provided on the load control switch. The lights indicate a status of the load control switch. for example when the lights are flashing green “H” light it indicates power is on, a green “L” light indicates connectivity to the utility, a red “D” light is on only when the load control switch is disconnecting the load controlled, usually in response to a signal sent by the utility. Depending on the type of load control event in progress, the load may cycle on and off, or remain off for the duration of the event. Once the Opt-out has been triggered, a yellow “I” light may flash until the event is complete, and the electrical load will not be turned off by the utility during this time. An audible sound may be provided by a speaker integrated into the load control switch when an Opt-out state has changed. The consumer can then easily Opt-out of load control events when required without a need to interact with a load control switch directly.

Although certain system, methods, and apparatus are described herein, the scope of coverage of this disclosure is not limited thereto. To the contrary, this disclosure covers all methods, apparatus, computer readable memory, and articles of manufacture fairly falling within the scope of the appended claims either literally or under the doctrine of equivalents

1. A method of operating a load control switch coupled between an electrical supply and an electrical load, the method comprising:
receiving an infra-red signal at the load control switch; and
masking a load control event when the infra-red signal is sustained for a pre-defined time interval, the load control event defining one or more time periods during which the electrical load is to be disconnected from the supply by the load control switch.

2. The method of claim 1 further comprising:
receiving the load control event prior to receiving the infra-red signal from a wireless receiver.

3. The method of claim 1 further comprising:
receiving the load control event after receiving the infra-red signal from a wireless receiver wherein the masking of the load control event is applied to a subsequent load control event.

4. The method of claim 1 wherein the masking of the local control event is applied to only a first time period defined by the load control event.

5. The method of claim 1 further comprising:
receiving a second infra-red signal at the load control switch;
unmasking the load control event allowing the load control switch to disconnect the electrical supply from the electrical load during the designated one or more time periods of the load control event if the second infra-red signal was sustained for a second defined time interval.

6. The method of claim 1 wherein the infra-red signal is in the 980 nm wavelength range.

7. The method of claim 1 wherein the infra-red signal is generated by an unknown device.

8. The method of claim 1 wherein the IR signal comprises IR pulses.

9. The method of claim 8 wherein the IR signal pulses last at least 350 usec and be repeated with a period no longer than 3 msec.

10. The method of claim 1 further comprising providing confirmation that disconnection from the electrical supply from the electrical load during the load control event has been masked.

11. The method of claim 10 wherein the confirmation is visual or audible.

12. A load control switch comprising:
an infra-red receiver;
a switch coupling and electrical supply and electrical load wherein the switch enables the electrical load to be disconnected from the electrical supply;
a processor for:
receiving an infra-red signal from the infra-red receiver; and
masking a load control event when the infra-red signal is sustained for a pre-defined time interval, the load control event defining one or more time periods during which the switch is to disconnect the electrical load from the supply.

13. The load control switch of claim 12 further comprising:
a wireless receiver for receiving the load control event wherein if the load control event is received after receiving the infra-red signal the masking of the load control event is applied to a subsequent load control event received.

14. The load control switch of claim 13 wherein the wireless receiver is selected from the group comprising:
a frequency modulated (FM) radio data service (RDS) receiver;
a paging receiver;
a very high frequency receiver;
a Zigbee receiver; and
a Wi-Fi receiver.

15. The load control switch of claim 12 wherein the masking of the local control event is applied to only the first time period defined by the load control event.

16. The load control switch of claim 12 further comprising:
receiving a second infra-red signal at the load control switch;
unmasking the load control event allowing the load control switch to disconnect the electrical supply from the electrical load during the designated one or more time periods of the load control event if the second infra-red signal was sustained for a second defined time interval.

17. The load control switch of claim 12 wherein the infra-red signal is in the 980 nm wavelength.

18. The load control switch of claim 12 wherein the infra-red signal is generated by an unknown device.

19. The load control switch of claim 12 wherein the IR signal comprises IR pulses.

20. The load control switch of claim 19 wherein the IR signal pulses last at least 350 usec and be repeated with a period no longer than 3 msec.

21. The load control switch of claim 12 further comprising providing confirmation that disconnection from the electrical supply from the electrical load during the load control event has been masked.

22. The load control switch of claim 22 wherein the confirmation is visual by a light emitting diode or audible by a speaker.
